(19) United States
(12) Patent Application Publication
(10) Pub. No.: US 2026/0226306 A1
(43) Pub. Date: Aug. 6, 2026

(54) Heat Seal Coatings

(71) Applicant: ARKEMA FRANCE, Puteaux (FR)

(72) Inventor: Chenyan Bai, Shanghai (CN)

(73) Assignee: ARKEMA FRANCE, Puteaux (FR)

(21) Appl. No.: 19/152,987

(22) PCT Filed: Feb. 2, 2023
(86) PCT No.: PCT/CN2023/074282

§ 371 Date: Aug. 1, 2025

(51) Int. Cl. C09D 133/08; C09D 5/02; C09D 7/65

(52) U.S. Cl. CPC C09D 133/08; C09D 5/022; C09D 7/65

(57) ABSTRACT

A water based coating comprising 35 to 60 wt. % of a first polyacrylate emulsion and 30 to 45% of a second polyacrylate emulsion is disclosed. The first polyacrylate emulsion can comprise a 1.4 to 5.6 ratio of butyl acrylate to styrene while the second polyacrylate emulsion can comprise a 0.4 to 1.3 ratio of butyl acrylate to styrene. The first polyacrylate emulsion can have a glass transition temperature of from −25° C. to 10° C. and the second polyacrylate emulsion can have a glass transition temperature of from 15° C. to 45° C. The water based coating can also include a water based tackifier, a wax emulsion, and/or a water based ethylene vinyl acetate resin. The water based coating can be applied to an aluminum substrate used to form enclosures with PVC blisters. The water based coating thus formed leads to a heat seal strength at 150° C. above 5.6N/15 mm, a heat seal strength above 5.2 after ten days of aging and good anti-blocking at 50° C.

### FIELD

The current disclosure relates to heat seal coatings. More particularly the current disclosure relates to water based heat seal coatings. Even more particularly the current disclosure relates to water based heat seal coatings used in blister lidding foil preparation.

### INTRODUCTION

Heat seal coatings are currently based mainly on solvent based or water base ethylene vinyl acetate and ethylene acrylic acid chemistries.

### SUMMARY OF DISCLOSURE

A water based coating comprising two polyacrylate emulsions is disclosed. The water based coating can comprise 35 to 60 wt. % of the first polyacrylate emulsion based on the weight of the water based coating. The water based coating can comprise 30 to 45 wt. % of the second polyacrylate emulsion based on the weight of the water based coating. The first polyacrylate emulsion can comprise butyl acrylate and styrene. The first polyacrylate emulsion can comprise a butyl acrylate to styrene ratio from 1.4 to 5.6. The second polyacrylate emulsion can comprise butyl acrylate and styrene. The second polyacrylate emulsion can comprise a butyl acrylate to styrene ratio from 0.4 to 1.3. The first polyacrylate emulsion can have a glass transition temperature of from −25° C. to 10° C. and the second polyacrylate emulsion can have a glass transition temperature of from 15′C to 45° C.

### DETAILED DESCRIPTION

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; etc.).

The term “composition” refers to a mixture of materials which comprise the composition, as well as reaction products and decomposition products formed from the materials of the composition.

As used herein, the term “polymer” means a polymeric compound prepared by polymerizing monomers, whether of the same or a different type. The generic term polymer thus embraces the term homopolymer (employed to refer to polymers prepared from only one type of monomer), and the term copolymer or interpolymer. Trace amounts of impurities (for example, catalyst residues) may be incorporated into and/or within the polymer. A polymer may be a single polymer, a polymer blend, or a polymer mixture, including mixtures of polymers that are formed in situ during polymerization.

As used herein, the term “polyolefin” means a polymer that comprises, in polymerized form, a majority amount of olefin monomer, for example ethylene or propylene (based on the weight of the polymer), and optionally may comprise one or more comonomers.

As used herein, the term “copolymer” means any polymer having two or more monomers.

### Water Based Coating

The disclosed water based coating can comprise a first and second polyacrylate emulsion. The water based coating can comprise 35 to 60 wt. % of the first polyacrylate emulsion based on the weight of the water based coating. All internal values and ranges are disclosed. For example, the water based coating can comprise from 35 to 45 or from 40 to 55 wt. % of the first polyacrylate emulsion based on the weight of the water based coating.

The water based coating can comprise from 30 to 45 wt. % of the second polyacrylate emulsion based on the weight of the water based coating. All internal values and ranges are disclosed. For example, the water based coating can comprise from 35 to 40 wt. % of the second polyacrylate emulsion based on the weight of the water based coating.

The water based coating can comprise a water based tackifier. The water based coating can comprise from 0 to 10 wt. % of the water based tackifier based on the weight of the water based coating. All internal values and ranges are disclosed. For example, the water based coating can comprise from 0 to 5 or from 5 to 10 wt. % of the water based tackifier based on the weight of the water based coating.

The water based coating can comprise a wax emulsion. The water based coating can comprise from 0 to 10 wt. % of the wax emulsion based on the weight of the water based coating. All internal values and ranges are disclosed. For example, the water based coating can comprise from 1 to 9 wt. % of the water wax based on the weight of the water based coating.

The water based coating can comprise a water based ethylene vinyl acetate resin. The water based coating can comprise from 0 to 30 wt. % of the ethylene vinyl acetate resin based on the weight of the water based coating. All internal values and ranges are disclosed. For example, the water based coating can comprise from 5 to 15 or 15 to 30 wt. % of the ethylene vinyl acetate resin based on the weight of the water based coating.

The water based coating can comprise filler. The water based coating can comprise from 0 to 5 wt. % of the filler based on the weight of the water based coating. The filler have a particle size below 6 μm.

The water based coating can comprise zero polyurethane dispersions (PUDs). The water based coating can comprise zero natural rubber. The water based coating can optionally comprise polyurethane dispersions (PUDs). The water based coating can optionally comprise natural rubber.

Laminates produced using the water based coating can have a heat seal strength greater than or equal to 7.5N/15 mm. Laminates produced using the water based coating can have a heat seal strength at 150° C. of from 7.5 to 11.0N/15 mm. All internal values and subranges are disclosed. For example, laminates produced using the water based coating can have a heat seal strength at 150° C. of from 7.5 to 8.5N′15 mm or from 10 to 11.0N/15 mm.

### First Polyacrylate Emulsion

The first polyacrylate emulsion can comprise a butyl acrylate to styrene ratio of from 1.4 to 5.6. All individual values and subranges are disclosed. For example the first polyacrylate emulsion can comprise a butyl acrylate to styrene ratio from a lower limit of 1.5, 1.6, 1.8, 2.0, 2.2, 2.4, 2.6, 2.8, 3.0, 3.2, 3.4, 3.6, 3.8, 4.0, 4.2, 4.4, 4.6, 4.8, or 5.0 to an upper limit of 5.6, 5.4, 5.2, 5.0, 4.8, 4.6, 4.4, 4.2, 4.0, 3.8, 3.6, 3.4, 3.2, 3.0, 2.8, 2.6, 2.4, 2.2, or 2.0.

The first polyacrylate emulsion can have a T_{g} of −25° C. to 10° C. All individual values and subranges are disclosed. For example the first polyacrylate emulsion can have a T_{g} of from −20° C. to 5° C. or from −25° C. to −15° C.

The first polyacrylate emulsion can be produced by introducing an initiator into a kettle of water into which an emulsified monomer mixture is fed. The initiator can be configured to react with the at least one monomer, thereby forming an emulsion polymer comprising monomer subunits. The initiator can react with the monomer dispersed throughout the aqueous medium until all or substantially all of the monomer is polymerized. The end result can be a dispersion of polymer particles in the aqueous medium, the polymer particles comprising the monomer subunits. This dispersion is commonly referred to as an emulsion polymer. Additional oxidation-reduction initiator can be introduced to the emulsion polymer after all the monomer is fed to the emulsified polymer, in order to reduce monomer residue level.

Reduction-oxidation (redox) initiator systems consisting of at least one, usually inorganic, reducing agent and of an inorganic or organic oxidizing agent are particularly suitable. The oxidation component can comprise, for example, ammonium salts and alkali metal salts of peroxodisulfuric acid, e.g. sodium peroxodisulfate, hydrogen peroxide or organic peroxides, e.g. tert-butyl hydroperoxide, t-amyl hydroperoxide. The reduction component can comprise, for example, alkali metal salts of sulfurous acid, such as sodium sulfite, sodium hydrogen sulfite, alkali metal salts of disulfurous acid, such as sodium disulfite, bisulfite addition compounds with aliphatic aldehydes and ketones, such as acetone bisulfite, or reducing agents such as hydroxymethanesulfinic acid and its salts, Bruggolite® FF6 or isoascorbic acid. The redox initiator systems can be used along with soluble metal compounds with metallic components able to exist in a plurality of valency states.

Examples of common redox initiator systems are tert-butyl hydroperoxide/sodium bisulfite, tert-butyl hydroperoxide/isoascorbic acid, and tert-butyl hydroperoxide/sodium hydroxymethanesulfinate. The individual components, for example the reduction component, may also be mixtures, for example a mixture of the sodium salt of hydroxymethanesulfinic acid with sodium disulfite.

### Second Polyacrylate Emulsion

The second polyacrylate emulsion can comprise a butyl acrylate to styrene ratio of from 0.4 to 1.3. All individual values and subranges are disclosed. For example the second polyacrylate emulsion can comprise a butyl acrylate to styrene ratio from a lower limit of from 0.4, 0.5, 0.6, 0.8, or 1.0 to an upper limit of 1.3, 1.2, 1.0, 0.8, or 0.9.

The second polyacrylate emulsion can have a T_{g} of from 15° C. to 45° C. All internal values and subranges are disclosed. For example, the second polyacrylate emulsion can have a T_{g} of from 20° C. to 40° C. or 15° C. to 25° C.

The second polyacrylate emulsion can be produced by introducing an initiator into a kettle of water into which an emulsified monomer mixture is fed. The initiator can be configured to react with the at least one monomer, thereby forming an emulsion polymer comprising monomer subunits. The initiator can react with the monomer dispersed throughout the aqueous medium until all or substantially all of the monomer is polymerized. The end result can be a dispersion of polymer particles in the aqueous medium, the polymer particles comprising the monomer subunits. This dispersion is commonly referred to as an emulsion polymer. Additional oxidation-reduction initiator can be introduced to the emulsion polymer after all the monomer is fed to the emulsified polymer, in order to reduce monomer residue level.

Reduction-oxidation (redox) initiator systems consisting of at least one, usually inorganic, reducing agent and of an inorganic or organic oxidizing agent are particularly suitable. The oxidation component can comprise, for example, ammonium salts and alkali metal salts of peroxodisulfuric acid, e.g. sodium peroxodisulfate, hydrogen peroxide or organic peroxides, e.g. tert-butyl hydroperoxide, t-amyl hydroperoxide. The reduction component can comprise, for example, alkali metal salts of sulfurous acid, such as sodium sulfite, sodium hydrogen sulfite, alkali metal salts of disulfurous acid, such as sodium disulfite, bisulfite addition compounds with aliphatic aldehydes and ketones, such as acetone bisulfite, or reducing agents such as hydroxymethanesulfinic acid and its salts, Bruggolite® FF6 or isoascorbic acid. The redox initiator systems can be used along with soluble metal compounds with metallic components able to exist in a plurality of valency states.

Examples of common redox initiator systems are tert-butyl hydroperoxide/sodium bisulfite, tert-butyl hydroperoxide/isoascorbic acid, and tert-butyl hydroperoxide/sodium hydroxymethanesulfinate. The individual components, for example the reduction component, may also be mixtures, for example a mixture of the sodium salt of hydroxymethanesulfinic acid with sodium disulfite.

### Tackifier

The water based coating can comprise 0 to 10 wt. % of water based tackifier based on the weight of the water based coating. All internal values and ranges are disclosed. For example, the water based coating can comprise from 3 to 9 wt. % of water based tackifier based on the weight of the water based coating.

The tackifier can have a melting temperature of from 60 to 150° C. All internal values and subranges are disclosed. For example, the tackifier can have a melting temperature of from 70 to 120° C. Examples of suitable tackifiers include but are not limited to rosin resin.

### Wax

The water based coating may comprise 0 to 10% of the wax emulsion based on the weight of the water based coating. The wax emulsion may comprise carnauba wax or paraffin wax. The wax emulsion may have a melting temperature between 50° C. to 150° C.

### Water Based Ethylene Vinyl Acetate Resin

The water based ethylene vinyl acetate resin can comprise from 4 to 40 wt. % of vinyl acetate. All individual values and subranges are disclosed. For example the vinyl acetate resin can comprise from 18 to 33 wt. % ethylene vinyl acetate.

### Testing Procedures

### Glass Transition Temperature (Tg)

A droplet of latex is dripped into an aluminum crucible and kept in the hood for 3 days to dry at room temperature. Then the sample is tested using a DSC Q2000 from TA instruments using

| | | |
|---|---|---|
| this program: [symbol] raise temperature from −80 | [symbol] 3. raise temperature from | ° C. to 170° C. b [symbol] |
| Cool down to −80 | | ° C. to 170° C. b [symbol] |

[symbol]

indicates data missing or illegible when filed

of transition is defined as the glass transition temperature (Tg).

### Heat Seal Strength

The coated Al/HSC is sealed to PVC substrate at 150° C. with 300 Ns of pressure and a is dwell time then cooled down to room temperature. Three strips are tested for each sample and the average value is calculated in units of N/15 mm.

### Anti-Blocking Resistance

The samples coated with the water heat seal coatings are cut into 100 mm×100 mm size samples, and then four pieces of samples are stacked together in a back to face sequence and laid on a flat glass. A 1.0 kg weight is then placed on top of them. This arrangement is then placed into a 50° C. oven for two hours. The arrangement is then removed and check whether the coating surface stuck to the back side or not.

### EXAMPLES

The materials used are listed below in table 1. All DOW™ commercial samples used are available from DOW™ Chemical.

TABLE 1
Raw material list

| Sample code | Composition | Supplier |
|---|---|---|
| Adcote 37P295BW | EVA based resin | Dow |
| Butyl Acrylate | Monomer | Dow Chemical |
| Styrene | Monomer | Dow Chemical |
| Surfactant | DS-4 | Solvery |
| Acrylic Acid | Monomer | Dow Chemical |
| Ammonium Persulfate | Oxidant | Sinopharm Chemical |
| | | Reagent |
| Sodium Bisulfate | Reductant | Sinopharm Chemical |
| | | Reagent |
| Tert-Butylhydroperoxide-70% | Oxidant | Sinopharm Chemical |
| Solution | | Reagent |
| FF6 | Reductant | Brüggmann Chemical |
| Ammonia | Neutralizer | Sinopharm Chemical |
| | | Reagent |

### Polyacrylate Composition (PAC) Preparation

A monomer emulsion is prepared by charging 0.1%, based on total monomer amount, of surfactant into deionized water. As the mixture is agitated, styrene and butyl acrylate are slowly added until a monomer emulsion with 74% solid content and the BA/styrene ratio in table 2 is achieved. One percent surfactant, based on total monomer amount, and deionized water are charged into a 5-necked, 5 liter, round bottom flask equipped with a thermocouple, a cooling condenser and an agitator. The flask is then heated to 70° C. under nitrogen. A small amount of 2% acrylic acid in 60° C. deionized water is charged into a kettle. 4.5% of the previously prepared monomer emulsion is then charged into the kettle after which 0.3%, based on total monomer amount, ammonia persulfate (APS) in deionized water and 0.15%, based on total monomer amount, sodium bisulfite (SBS) in deionized water are charged into the kettle under agitation. When the exotherm peak occurs and the temperature rises to 70° C., the rest of the monomer, a 0.18% (based on total monomer amount) solution of ammonia persulfate (APS) in deionized water, and a 0.09% solution of sodium bisulfate (based on total monomer amount) in deionized water is fed into the kettle over 120 minutes while the polymerization reaction temperature is maintained at 69-71° C. After the addition is completed, the vessel that contained the monomer emulsion and the feeding tubes leading to the flask are rinsed with deionized water and the rinse is added back to the flask and fed into the kettle. The kettle is then held at 70° C. for 15 minutes while a tert-butyl hydroperoxide solution (0.08% based on total monomer amount, in deionized water) and a solution of FF6 (0.06%, based on total monomer content, in deionized water) is charged then held for another 15 minutes after charging is complete. A solution of tert-butyl hydroperoxide (0.29%, based on total monomer amount, in deionized water) and FF6 (0.25%, based on total monomer amount, in deionized water) is then gradually added over 60 minutes after which the reaction is cooled to room temperature. Ammonium solution is then added to adjust the pH value to between 6.5-7.5. The solid content of the completed polyacrylate sample should be 45%.

TABLE 2
Polyacrylate Compositions

| | Butyl Acrylate/ | Glass Transition |
|---|---|---|
| Sample | Styrene Ratio | Temperature ° C. |
| PAC 1 | 1 | 20 |
| PAC2 | 0.91 | 25 |
| PAC3 | 4 | −20 |

### Coating Process

The formulation from table 3 is coated onto Al substrate Dry coating weights are 2.0-2.5 gsm. After the Al is coated it is placed into a 80° C. oven for 1 minute to remove water after which the Al is removed from the oven and tested.

TABLE 3
Inventive and Comparative Examples

| | IE1 | IE2 | IE3 | IE4 | IE5 | IE6 | IE7 | IE8 | CE1 | CE2 | CE3 | CE4 |
|---|---|---|---|---|---|---|---|---|---|---|---|---|
| PAC 1 | 30 | 35 | 40 | 33 | 40 | 36 | 39 | | 50 | 20 | 50 | 20 |
| PAC 2 | | | | | | | | 40 | | | | |
| PAC 3 | 40 | 45 | 50 | 43 | 60 | 54 | 48 | 60 | 30 | 62 | 50 | 80 |
| Adcote | 30 | 20 | 10 | 20 | | | | | 20 | | | |
| 37P295 | | | | | | | | | | | | |
| Rosin | | | | | | 5 | 10 | | | 10 | | |
| resin | | | | | | | | | | | | |
| carnauba | | | | | | | 3 | | | | | |
| wax | | | | | | | | | | | | |
| Paraffin | | | | 3 | | 5 | | | | 5 | | |
| wax | | | | | | | | | | | | |
| Filler | | | | 1 | | | | | | 3 | | |

TABLE 4
performance results

| | IE1 | IE2 | IE3 | IE4 | IE5 | IE6 | IE7 | IE8 | CE1 | CE2 | CE3 | CE4 |
|---|---|---|---|---|---|---|---|---|---|---|---|---|
| Heat seal | 10.5 | 9.8 | 9.9 | 9.7 | 8.7 | 10.7 | 9.2 | 8.1 | 5.6 | 5.2 | 1.7 | 3.5 |
| strength at | | | | | | | | | | | | |
| 150 C. | | | | | | | | | | | | |
| (N/15 mm) | | | | | | | | | | | | |
| HS after | 9.0 | 8.8 | 8.7 | 9.1 | 9 | 10 | 9.8 | 7.6 | 5.2 | 4.2 | 1.6 | 3.0 |
| 10 days aging | | | | | | | | | | | | |
| @85 C., 85% | | | | | | | | | | | | |
| humidity | | | | | | | | | | | | |
| (N/15 mm) | | | | | | | | | | | | |
| Anti- | good | good | good | good | good | good | good | good | good | sticky | good | sticky |
| blocking@50 C. | | | | | | | | | | | | |

1. A water based coating comprising:
a. 35 to 60 wt. % of a first polyacrylate emulsion, based on the weight of the water based coating, wherein the first polyacrylate emulsion comprises:
i. butyl acrylate and styrene, and
ii. a butyl acrylate to styrene ratio from 1.4 to 5.6; and
b. 30 to 45 wt. %, based on the weight of the water based coating, of a second polyacrylate emulsion comprising:
i. butyl acrylate and styrene, and
ii. a butyl acrylate to styrene ratio from 0.4 to 1.3,
wherein the first polyacrylate emulsion has a glass transition temperature (T_{g}) of −25° C. to 10° C. and the second polyacrylate emulsion has a T_{g} of from 15° C. to 45° C.

2. The water based coating of claim 1, wherein the first polyacrylate emulsion comprises a butyl acrylate to styrene ratio from 1.5 to 5.

3. The water based coating of claim 1, wherein the second polyacrylate emulsion comprises a butyl acrylate to styrene ratio from 0.5 to 1.2.

4. The water based coating of claim 1, further comprising a water based tackifier.

5. The water based coating of claim 1, further comprising a wax emulsion.

6. The water based coating of claim 1, further comprising a water based ethylene vinyl acetate resin.

7. A laminate comprising a water based coating of claim 1.

8. (canceled)

9. (canceled)

10. A method of forming an enclosure with a PVC blister, the method comprising applying a water based coating of claim 1 to an aluminum substrate.

11. A water based coating comprising:
a. 35 to 60 wt. % of a first polyacrylate emulsion, based on the weight of the water based coating, wherein the first polyacrylate emulsion comprises:
i. butyl acrylate and styrene, and
ii. a butyl acrylate to styrene ratio from 1.4 to 5.6; and
b. 30 to 45 wt. %, based on the weight of the water based coating, of a second polyacrylate emulsion comprising:
i. butyl acrylate and styrene, and
ii. a butyl acrylate to styrene ratio from 0.4 to 1.3,
wherein the first polyacrylate emulsion has a glass transition temperature (T_{g}) of −25° C. to 10° C. and the second polyacrylate emulsion has a T_{g} of from 15° C. to 45° C., and
wherein the water based coating comprises from 0 to 10 wt. % of a wax emulsion based on the weight of the water based coating.

12. The water based coating of claim 11, further comprising no more than 10 wt. % of a water based tackifier, based on the weight of the water based coating.

13. A water based coating comprising:
a. 35 to 60 wt. % of a first polyacrylate emulsion, based on the weight of the water based coating, wherein the first polyacrylate emulsion comprises:
i. butyl acrylate and styrene, and
ii. a butyl acrylate to styrene ratio from 1.4 to 5.6; and
b. 30 to 45 wt. %, based on the weight of the water based coating, of a second polyacrylate emulsion comprising:
i. butyl acrylate and styrene, and
ii. a butyl acrylate to styrene ratio from 0.4 to 1.3,
wherein the first polyacrylate emulsion has a glass transition temperature (T_{g}) of −25° C. to 10° C. and the second polyacrylate emulsion has a T_{g} of from 15° C. to 45° C., and
wherein the water based coating comprises from 0 to 30 wt. % of an ethylene vinyl acetate resin, based on the weight of the water based coating.
